(19) United States
(12) Patent Application Publication
(10) Pub. No.: US 2025/0383280 A1
(43) Pub. Date: Dec. 18, 2025

(54) Spectroscopic Bioagent Detection

(71) Applicant: Board of Trustees of Michigan State University, East Lansing, MI (US)

(72) Inventor: Elad HAREL, Okemos, MI (US)

(73) Assignee: Board of Trustees of Michigan State University, East Lansing, MI (US)

(21) Appl. No.: 19/234,410

(22) Filed: Jun. 11, 2025

Related U.S. Application Data
(60) Provisional application No. 63/660,050, filed on Jun. 14, 2024.

(51) Int. Cl. G01N 15/14; G01N 15/1434

(52) U.S. Cl. CPC G01N 15/1425; G01N 15/1434

(57) ABSTRACT

A spectroscopic bioagent detection apparatus and method are provided. In one aspect, an optical detection system and method are used to identify and/or detect a virus or bacteria by using a microscope and measuring vibrational motion or phonons of the virus or bacteria. A further aspect of the present apparatus and method include automatically optically measuring vibrational motion or phonons of a target virus or bacteria, substantially in real-time, in vivo or in situ, automatically filtering out undesired background and living cell signals, and automatically identifying a characteristic of the virus or bacteria.

### CROSS-REFERENCE TO RELATED APPLICATION

This application claims priority to U.S. provisional application Ser. No. 63/660,050, filed on Jun. 14, 2024, which is incorporated by reference herein.

### GOVERNMENT SUPPORT

This invention was made with government support under DTRA-HDTRA12110026 awarded by the Defense Threat Reduction Agency, part of the Department of Defense. The government has certain rights in the invention.

### BACKGROUND AND SUMMARY

The present application generally pertains to spectroscopy and more particularly to spectroscopic bioagent detection.

Recent studies of virus dynamics of isolated RNA bacteriophage through scattering interference microscopy have revealed kinetics of capsid self-assembly. However, experiments in live cells where the scattering signal from cellular compartments is orders of magnitude stronger precludes tracking virus dynamics in vivo. Other known methods, such as photothermal mid-infrared spectroscopy which have demonstrated single virus sensitivity, only probe local IR-active modes, namely amide I and amide II bond vibrations. Such modes are prevalent throughout the cell which is composed of proteins, lipids, and nucleic acids, and therefore dominate over signals from virus particles. In general, optical spectroscopic methods that only probe local properties (for example, Raman, IR and UV/visible absorption) fail to differentiate cellular biomolecules and organelles from unlabeled viruses. While fluorescence labeling is an attractive and potentially powerful approach to studying virus pathogenesis in vivo, it is inherently limited due to its dense structure and the potential of labeling to compromise functionality. Furthermore, traditional photobleaching greatly restricts the observation time which prevents continuous monitoring of the entire infection process at high resolution. Finally, traditional fluorescence is highly limited in its information content as it primarily provides spatial localization rather than details of structure or dynamics.

In accordance with the present invention, a spectroscopic bioagent detection apparatus and method are provided. In one aspect, an optical detection system and method are used to identify and/or detect a virus or bacteria by using a microscope and measuring vibrational motion or phonons of the virus or bacteria. A further aspect of the present apparatus and method include automatically optically measuring vibrational motion or phonons of a target virus or bacteria, substantially in real-time, in vivo or in situ, automatically filtering out undesired background and living cell signals, and automatically identifying a characteristic of the virus or bacteria (such as size, shape or surface proteins thereof), without the need for a nano-or micro-mechanical device, such as a microresonator.

Another aspect of the present apparatus and method include automatically optically measuring vibrational motion or phonons of a target living virus or bacteria, for use in clinical identification of the virus or bacteria. Yet another aspect of the present apparatus and method include automatically optically measuring vibrational motion or phonons of a target living virus or bacteria, for use in developing new pharmaceutical drugs by observing the substantially real-time interactions and/or effects of the drug on the virus or bacteria. Another aspect of the present apparatus and method include automatically optically measuring vibrational motion or phonons of a target virus, for use in automatically determining quantity or viral load, and/or if the virus is intact or active.

In a viral fingerprinting aspect of the present apparatus and method, a target bioagent is first tethered or immobilized, in a uniform environment, such as on a glass slide, second, widefield microscopy is used to optically identify a single or target particle (e.g., a virus or bacterium), third, the single or target particle is positioned at a focal point or volume of a laser, fourth, the single or target particle is optically vibrated by using near-infrared (NIR) light to generate vibrational motion by impulsive Raman scattering processes or the like (i.e., without use of a mechanical resonator), and fifth, a vibrational frequency spectrum is detected from the single or target particle. A further aspect employs a microprocessor controller and software instructions programmed therein, and stored in non-transient RAM or ROM memory, to automatically: cause optical and laser-induced vibration of a target live bioagent, detect a vibrational frequency spectrum generated by the target bioagent, compare the spectrum to a predetermined database stored in memory, and determine a characteristic of the target bioagent such as surface proteins thereon, size, shape, loading, intactness/activity and/or identity thereof.

The present apparatus and method are advantageous over traditional approaches. For example, the present system is less complex, less expensive and faster than traditional mechanical microresonators which require the target virus identity to already be known and vibrational frequencies matched. The present apparatus and method beneficially operate across a 100 MHz to 100 THz frequency range to allow it to detect and identify the target bioagent even when its characteristics and type are unknown before commencing. Conventional microresonators have very limited bandwidth (typically >1 GHz), so that is why the target, or at least its mass, has to be know. But with the present method, the bandwidth can be as high as 100 THz (i.e., 100,000 more than the resonator) which means that the present method can beneficially detect a very wide range of sizes/shapes/masses.

Moreover, the present apparatus and method employ cutoff or filtering of undesired background noise signals, such as a live cell to which a virus is attached, blood or debris, so that the sensed vibrational characteristics of the target bioagent can be enhanced or magnified for further detection. This cutoff or filtering can occur with physical masks to block out low spatial frequency photons and, more uniquely, with electronic filters that block the low-frequency components of the signals generated from photodetectors. The physical masks are useful so as not to saturate the detector with scattering from large objects like cell membranes, while the electronic filtering is useful to block the majority of the signal that does not modulate at high frequencies.

The present apparatus and method are ideally suited for observing and detecting real-time interaction and effects of pharmaceutical drugs on a live virus or bacteria. Additional features and advantages of the present apparatus and method will become apparent from the following description and claims, in addition to the appended figures.

### BRIEF DESCRIPTION OF THE DRAWINGS

FIG. 1 is a diagram showing excitation vibration of a virion using the present spectroscopic bioagent detection apparatus and method;

FIG. 2 is a diagram showing a pump laser and a probe laser to vibrate the virion using the present spectroscopic bioagent detection apparatus and method;

FIG. 3 is a diagram showing a time delay pulse sequence from the pump laser and the probe laser using the present spectroscopic bioagent detection apparatus and method;

FIG. 4 is a diagram showing a simulation of simultaneous excitation of breathing (br), shearing and axial (ax) vibrational modes in a nanoparticle near a substrate using the present spectroscopic bioagent detection apparatus and method;

FIG. 5 is a graph showing a simulation of simultaneous excitation vibrational modes as a function of time, using the present spectroscopic bioagent detection apparatus and method;

FIG. 6 is a graph showing a simulation of simultaneous excitation vibrational modes as a function of frequency, using the present spectroscopic bioagent detection apparatus and method;

FIG. 7 is a graph showing excitation vibrational spectra as a function of time for a single gold nanoparticle, using the present spectroscopic bioagent detection apparatus and method;

FIG. 8 is a graph showing excitation vibrational spectra as a function of frequency for a single gold nanoparticle, using the present spectroscopic bioagent detection apparatus and method;

FIG. 9 is a graph showing excitation vibrational spectra as a function of time for a single lentivirus virion, using the present spectroscopic bioagent detection apparatus and method;

FIG. 10 is a graph showing excitation vibrational spectra as a function of frequency for a single lentivirus virion, using the present spectroscopic bioagent detection apparatus and method;

FIG. 11 is a diagram showing a tethered gold nanoparticle in the present spectroscopic bioagent detection apparatus and method;

FIG. 12 is a graph showing an average time-domain response and standard deviation for the tethered gold nanoparticle, using the present spectroscopic bioagent detection apparatus and method;

FIG. 13 is a graph showing an average time series as a function of frequency for the tethered gold nanoparticle, using the present spectroscopic bioagent detection apparatus and method;

FIG. 14 is a graph showing a frequency peak shift relative for the tethered gold nanoparticle, using the present spectroscopic bioagent detection apparatus and method;

FIG. 15 is a graph showing a relative peak shift broadening as a function of lab time for the tethered gold nanoparticle, using the present spectroscopic bioagent detection apparatus and method;

FIG. 16 is a diagram showing an untethered gold nanoparticle in the present spectroscopic bioagent detection apparatus and method;

FIG. 17 is a graph showing an average time-domain response and standard deviation for the untethered gold nanoparticle, using the present spectroscopic bioagent detection apparatus and method;

FIG. 18 is a graph showing an average time series as a function of frequency for the untethered gold nanoparticle, using the present spectroscopic bioagent detection apparatus and method;

FIG. 19 is a graph showing a frequency peak shift relative to a first time trace for the untethered gold nanoparticle, using the present spectroscopic bioagent detection apparatus and method;

FIG. 20 is a graph showing a relative peak shift broadening as a function of lab time for the untethered gold nanoparticle, using the present spectroscopic bioagent detection apparatus and method;

FIG. 21 is a set of graphs showing a single virion trajectory over 12 minutes illustrating gradual phonon softening and sudden virion rupturing, using the present spectroscopic bioagent detection apparatus and method;

FIG. 22 is a set of graphs showing a single virion trajectory illustrating both axial and breathing modes as well as weaker shearing modes, using the present spectroscopic bioagent detection apparatus and method;

FIG. 23 is a diagram showing the single virion at different time points, associated with FIG. 21, using the present spectroscopic bioagent detection apparatus and method;

FIG. 24 is a diagram showing the single virion at different time points, associated with FIG. 22, using the present spectroscopic bioagent detection apparatus and method;

FIG. 25 is a graph showing an enlarged spectrum of a second virus in the 2.5-10 GHz region, using the present spectroscopic bioagent detection apparatus and method;

FIG. 26 is a graph showing correlations between the breathing mode frequency and dephasing rates, with the black triangles and circles indicating the second virus and the empty triangles and circles indicating the first virus, using the present spectroscopic bioagent detection apparatus and method;

FIG. 27 is a set of graphs showing a change in the relative dephasing rate for the breathing mode peak and axial mode peak from FIG. 22 as a function of time in the left graph, and a frequency shift of the breathing and axial modes in the right graph, using the present spectroscopic bioagent detection apparatus and method;

FIG. 28 is a set of graphs showing an offset frequency determining a scan rate between two pulse trains, with the signal being down converted from molecular time to lab time by a ratio of the offset to the laser repetition rate in the upper graph, and in relation between the lab time and molecular time in the lower graph, using the present spectroscopic bioagent detection apparatus and method;

FIG. 29 is a chart showing a trigger sequence and data structure, using the present spectroscopic bioagent detection apparatus and method;

FIG. 30 is a graph showing a 100 nm gold nanoparticle background subtraction procedure with regard to an original signal from a digitizer, using the present spectroscopic bioagent detection apparatus and method;

FIG. 31 is a graph showing a 100 nm gold nanoparticle background subtraction procedure with regard to a signal in a molecular frame and a low-frequency component of the fit, using the present spectroscopic bioagent detection apparatus and method;

FIG. 32 is a graph showing a 100 nm gold nanoparticle background subtraction procedure with regard to a residual of the signal from FIG. 31 and its low-frequency fit, using the present spectroscopic bioagent detection apparatus and method;

FIG. 33 is a graph showing a 100 nm gold nanoparticle background subtraction procedure with regard to the FFT of the residual shown in FIG. 32, with the dashed line representing an expected center frequency of a high-pass filter at 22 KHz, using the present spectroscopic bioagent detection apparatus and method;

FIG. 34 is a graph showing a 100 nm gold nanoparticle background subtraction procedure with regard to the FFT of the residual from FIG. 32 illustrating acoustic modes, with the dashed line representing an expected cut-off frequency from a balanced photodiode, using the present spectroscopic bioagent detection apparatus and method;

FIG. 35 is a graph showing a LentiGFP background subtraction procedure with regard to an original signal from a digitizer, using the present spectroscopic bioagent detection apparatus and method;

FIG. 36 is a graph showing a LentiGFP background subtraction procedure with regard to a signal in a molecular frame and a low-frequency component of the fit, using the present spectroscopic bioagent detection apparatus and method;

FIG. 37 is a graph showing a LentiGFP background subtraction procedure with regard to a residual of the signal from FIG. 31 and its low-frequency fit, using the present spectroscopic bioagent detection apparatus and method;

FIG. 38 is a graph showing a LentiGFP background subtraction procedure with regard to the FFT of the low-frequency fit, with the dashed line representing an expected center frequency of a high-pass filter at 5 KHz, using the present spectroscopic bioagent detection apparatus and method;

FIG. 39 is a graph showing a LentiGFP background subtraction procedure with regard to the FFT of the residual from FIG. 37 illustrating acoustic modes, with the dashed line representing an expected cut-off frequency from a balanced photodiode, using the present spectroscopic bioagent detection apparatus and method;

FIG. 40 is a graph showing an effect of signal averaging for a single gold nanoparticle, with each trace corresponding to 1000× on-board averaging and further magnification averaging, using the present spectroscopic bioagent detection apparatus and method;

FIG. 41 is a graph showing an effect of signal averaging for a single Lenti virion, with each trace corresponding to 1000× on-board averaging and further magnification averaging, using the present spectroscopic bioagent detection apparatus and method;

FIG. 42 is a graph showing untethered, single 100 nm gold nanoparticle trajectory as a function of time delay, using the present spectroscopic bioagent detection apparatus and method;

FIG. 43 is a graph showing untethered, single 100 nm gold nanoparticle trajectory as a function of frequency, using the present spectroscopic bioagent detection apparatus and method;

FIG. 44 is a graph showing tethered, single 100 nm gold nanoparticle trajectory as a function of time delay, using the present spectroscopic bioagent detection apparatus and method;

FIG. 45 is a graph showing tethered, single 100 nm gold nanoparticle trajectory as a function of frequency, using the present spectroscopic bioagent detection apparatus and method;

FIG. 46 is a first embodiment of an epi microscopy hardware setup, using the present spectroscopic bioagent detection apparatus and method;

FIG. 47 is a software logic flow diagram of the present spectroscopic bioagent detection apparatus and method;

FIG. 48 is a diagram of software logic used in the present spectroscopic bioagent detection apparatus and method; and

FIG. 49 is a second embodiment of a microscopy hardware setup, using the present spectroscopic bioagent detection apparatus and method.

### DETAILED DESCRIPTION

The natural vibrational frequencies of biological particles, such as viruses and bacteria encode unique information about their mechanical and biological states. When the particles dynamically interact with their environment, it causes modulations in their collective vibrational motion. The present apparatus and method detect and track the collective vibrational motions of single, unlabeled virus particles, or virions, under ambient conditions using time-resolved ultrafast spectroscopy. The ultrasonic spectrum of an 80-100 nm lentiviral pseudovirion reveals vibrational modes in the 19-21 GHz range sensitive to virus morphology and in the 2-5 GHz range with nanosecond dephasing times that reflect interactions of the envelope proteins with their environment. By tracking virion trajectories over many minutes, acoustic mode coupling mediated by the virion-substrate interaction is observed. Single virion tracking provides insights into viral disassembly by capturing the sudden rupture of an intact virion through correlated mode softening and dephasing. The sensitivity, high-resolution, and speed of the present approach deepens an understanding of dynamics of biological systems such as microbial pathogenesis in vivo and paves the way for early-state diagnostics at the single microorganism level.

The low-frequency vibrations of biological systems such as proteins, viruses, and bacteria, reflect collective motion of all their constituent atoms. The vibrational spectra of these biological systems, therefore, reflect their three-dimensional structure and conformational flexibility, as well as interactions with their environment. It is desirable to detect these low-frequency vibrations in the hundreds of MHz to THz range within a biological environment. It is also desirable to avoid restricting motion of the target particles, to allow tracking of dynamics as the particle environment changes. The present method and apparatus provide an all-optical method for detection and tracking of acoustic vibrations in a small, biological particle—a single virion smaller than 100 nm. Furthermore, the present method and apparatus measure acoustic spectra in the 0.1-2000 GHz range, and more preferably in the 2-50 GHz range, that are exceptionally sensitive to morphology and interactions of the envelope proteins with the environment.

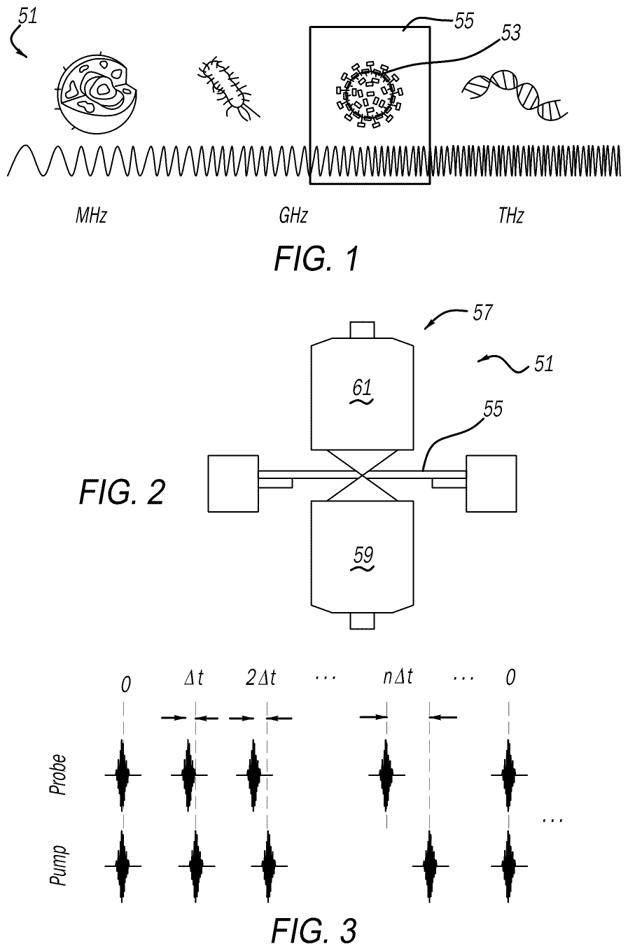

The present spectroscopic bioagent detection apparatus 51 and method are illustrated in FIGS. 1-10, wherein a target virus sample 53 is placed on a glass cover slip or slide 55 without further modification and is interrogated with a pair of ultrashort laser pulses inside a microscope 57. A non-resonant pump pulse (for example, <100 fs, 1040 nm) is emitted from a pump laser 59 to excite collective vibrations in virion 53, and a second, time-delayed probe pulse (for example, <100 fs, 785 nm) is emitted from a probe laser 61 to detect weak changes in light scattering induced by the coherent vibrations of the virion particle. The resulting weak signal is isolated from the large background of backscattered light by using balanced detection and asynchronous optical sampling (ASOPS), a method by which the inter-pulse delays are rapidly scanned up to the laser pulse period (for example, ˜10 ns) in sub-milliseconds to reduce laser and environmental noise.

FIG. 1 shows the dependence of the vibrational frequency on the size of the biological agent. The virus sits in the approximately 10-100 GHz range but can vary greatly depending on its size, shape and other characteristics. Next, FIG. 2 illustrates the objective lying above and below the sample plane. Note, the experiment can also be conducted with a single objective lens in an ‘epi’ configuration. The FIG. 3 diagram depict the pump and probe being scanned without moving parts using the ASOPS system.

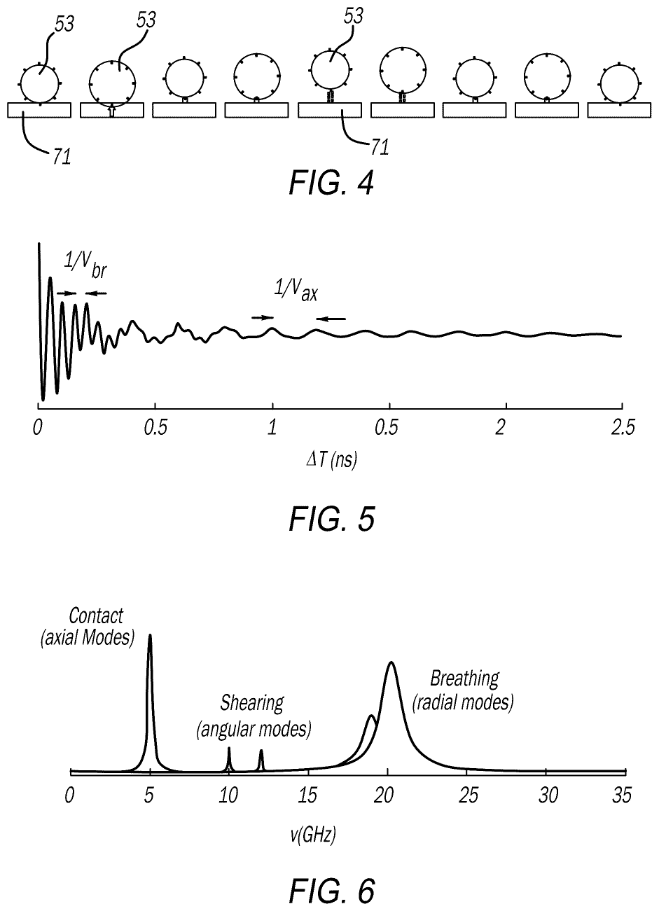

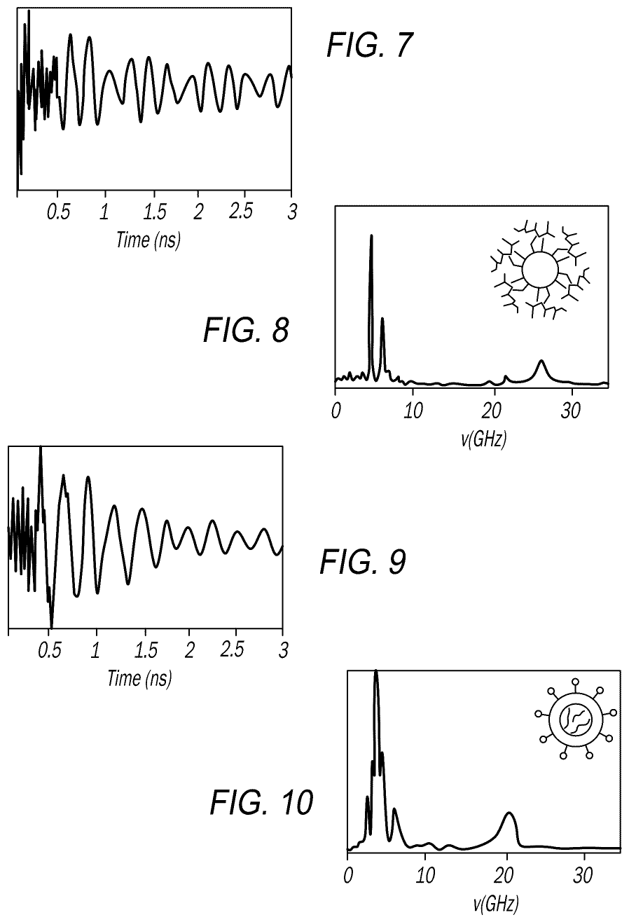

The time-domain response contains many different signal contributions depending on the resonance condition. Non-resonant excitation of the virions are of most interest whereby the pump pulse is far detuned from any electronic excitation in the sample. The coherence-only (i.e., oscillatory) component of the signal represents the acoustic phonon spectrum, composed of low-frequency Raman active vibrational modes in the 0.1 GHz-1 THz spectral region. Depending on the particle size, shape, and composition, three different types of vibrational modes are observed, as shown in FIGS. 4-6: i) an axial or contact mode at a very low frequency (for example, <5 GHz), which represents interactions of particle 53 with a substrate 71, ii) shearing or angular modes (for example, 10-20 GHz), which correspond to higher order vibrational motion represented by spherical harmonics, and iii) a breathing or radial mode (for example, ˜20 GHz), which represents contraction and expansion of the particle in a radially symmetric vibrational motion. The shearing modes may also be induced by breaking of the particle spherical symmetry near the surface. For comparison, the spectra of FIGS. 7-10 show, for a 100 nm spherical gold nanoparticle (AuNP) and an 80-100 nm lentiviral pseudovirion with a green fluorescence protein (GFP) gene inserted into its RNA genome (LentiGFP). Details of the spectra will be discussed below, but several salient features are highlighted here. Both spectra exhibit fast oscillations that persist for ˜500 ps and much slower oscillations that persist for at least 3 ns. These oscillations correspond to the breathing and axial modes, respectively, with the virion spectra exhibiting a more complex structure in the low frequency (for example, <10 GHz) region.

A similarly sized AuNP is first investigated under identical experimental conditions to better understand the complex acoustic spectrum of the spherical virus. The properties of the prominent radial breathing mode are studied using time-resolved ultrafast spectroscopy in a wide range of metallic nanoparticles, including gold, silver, and bi-metallics, and in varying sizes and shapes ranging from nanospheres and nanorods to multi-particle structures such as dimers and trimers. When metallic nanoparticles are illuminated with an ultrashort pulse, electrons within the Fermi energy are excited to higher lying states in the conduction band forming hot carriers which rapidly thermalize to a quasi-temperature in tens of femtoseconds. This is followed by thermalization with the lattice through electron-phonon interactions, which generates a photo-induced stress in the nanoparticles, launching coherent mechanical vibrations. The dielectric properties of the nanoparticle and its immediate surroundings are periodically modulated by these vibrations which induce a change in the reflection or transmission of a time-delayed probe pulse. Above a few nanometers, the acoustic properties of these systems are described by an elastic continuum model, which predicts that the radial breathing frequency scales inversely with the characteristic dimension of the nanostructure and with the square root of the ratio of the shearing modulus, G, to the particle density, ρ: v_{br}∝D⁻¹(G/ρ)^{1/2}, where D is the particle diameter.

Measurement of the pump-probe response provides information on both the acoustic frequency, v, as well as the phonon dephasing time, Γ. This dephasing is dictated by an interplay between the intrinsic anharmonicity of the lattice and other extrinsic factors, such as material impurities or defects. In addition to the radial breathing mode which dominates the signal below ˜500 ps, there may be other angular or shearing modes that represent non-spherically symmetric motions as well as harmonics of these modes. When the nanoparticle is in contact with a surface, a low-frequency axial mode is observed which depends on the adhesion force between the nanoparticle and the substrate. This interaction gives rise to a periodic motion of the particle position relative to the substrate which manifests as a few GHz mode for ˜100 nm AuNPs.

The breathing and axial modes for different diameter spherical AuNPs are related to one another according to classical Hertzian contact mechanics. In this model, the breathing mode modulates the penetration depth, δ, of the particle into the substrate and the stiffness k of the contact scales as k∝D^{2/3}. Therefore, the axial mode frequency fₐ, assuming a harmonic model, scales as

$${f}_{a} ∝ \sqrt{( k / m )} ∝ {f}_{0}^{7 / 6} ,$$

where f₀ is the radial breathing mode frequency and m is the mass, for a spherical NP (m∝D³). This theory predicts that the scaling between the two modes is independent of the particle size.

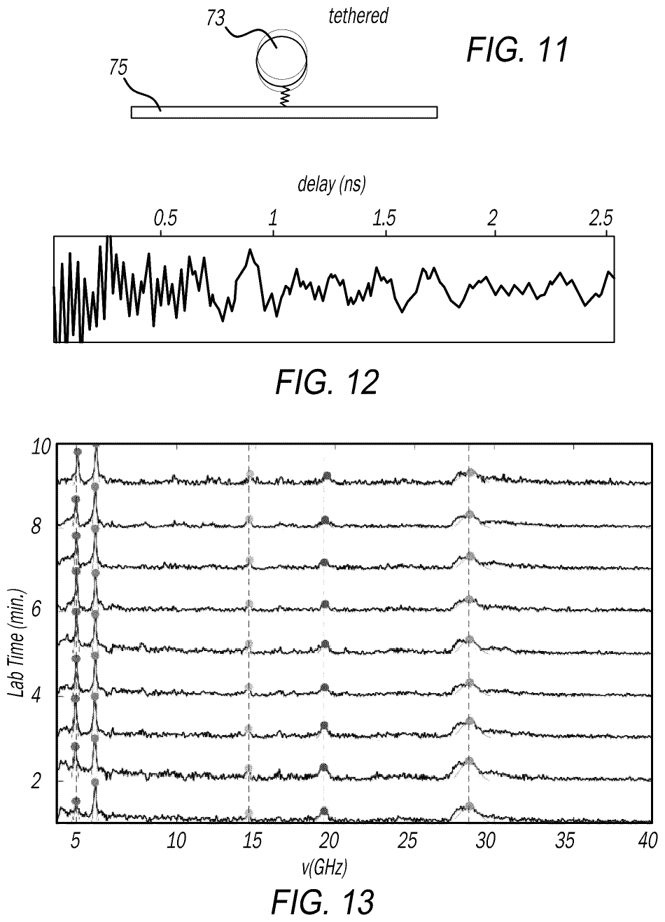

For a nanoparticle that is weakly coupled to the substrate, the axial and breathing modes do not change appreciably with time, as shown in FIGS. 11-13, for a 100 nm AuNP attached to a surface by a 0.5-1 nm long tether; more specifically, a (3-Aminopropyl)triethoxysilane (APTES) molecule 73 absorbed on a —OH terminated fused silica substrate 75. More specifically, FIG. 13 shows the change in the acoustic spectrum in lab time (e.g., increments of 1 minute, going from bottom to top).

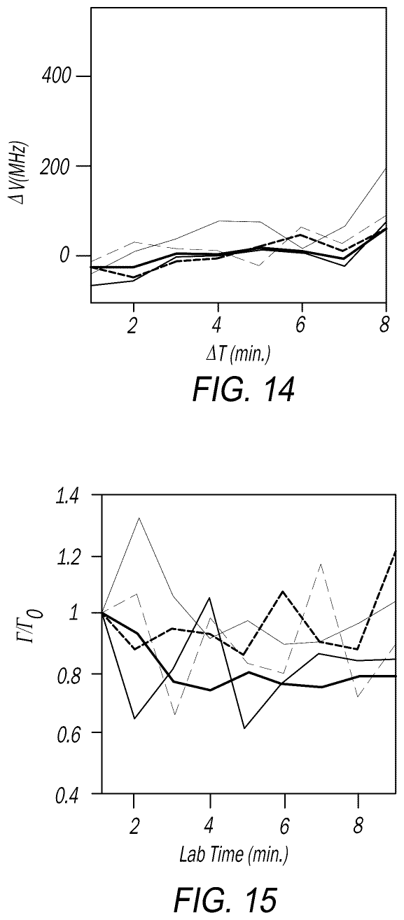

Tracking the same particle 73 over 10 minutes reveals only a minor shift of the axial, shearing, and breathing modes (<200 MHz) in the 2-30 GHz range, as well as no discernable correlation among the mode frequencies. See FIGS. 14 and 15. FIG. 14 shows that there is very small shift (within the margin of error) for the tethered AuNP case and FIG. 15 also depicts negligible changes in the peak shift. FIGS. 14 and 15 demonstrate that the spectra is very stable when the particle is tethered and there is a clean micro-environment around it.

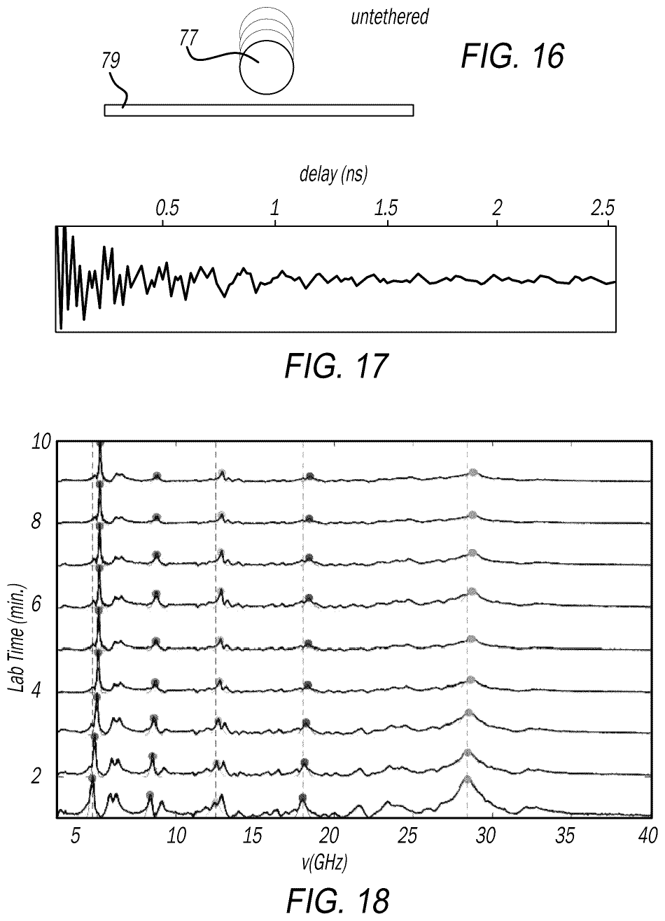

Referring to FIGS. 16-18, an untethered AuNP 77 of a nearly identical size is employed where adhesion forces between the nanoparticle and a substrate 79 are much stronger. Because the breathing modes for the two nanoparticles shown are identical to within the resolution of the measurement (<0.1 GHz), the characteristic diameter should be the same to within 0.3 nm (1-2 Au atoms). For the untethered AuNP, the amplitudes of the axial and shearing modes are much stronger relative to the breathing mode than those for the tethered particle. Only a single prominent axial mode near 5 GHz is observed for the untethered nanoparticle, while two modes are detected in the untethered nanoparticle, one at 3.65 GHz and the other at 4.7 GHz (compared to

$${v}_{ax}^{teth} ∼ 4.87$$

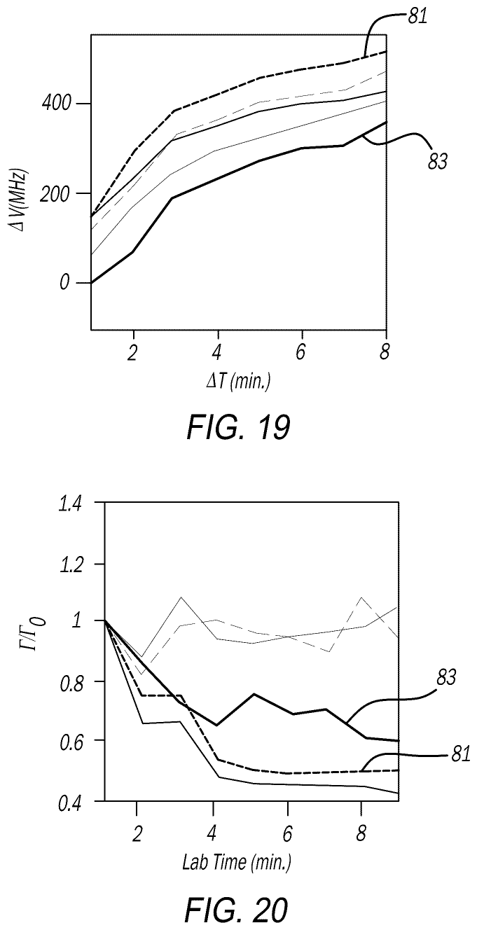

GHz). The splitting may be due to the tether acting like a mass on a spring in series between the nanoparticle and the substrate, giving rise to a new axial mode (3.65 GHz). In the untethered AuNP, evolution of the spectral features over several minutes reveals correlations among the mode frequencies as shown in FIGS. 19 and 20.

For the five modes analyzed, selected because of their relative isolation from nearby peaks, the acoustic frequencies all blue-shifted with experimental time. This blueshift occurred to varying degrees for nearly all the single particle measurements performed due to a gradual increase of the interaction between the nanoparticle and the substrate. This effect may arise from prolonged laser exposure which gradually ablates or otherwise removes organic material between the nanoparticle and the substrate causing stronger association between them. Regardless of the mechanism, the spectral evolution observed offers insights into the correlations and couplings among these modes. Such correlations may only be measured by single particle tracking because variations in size, shape, and other material properties such as defects, multiple crystal facets and dislocations, and ligand coverage, dominate the observed spectral changes among nanoparticles synthesized from the same batch.

As shown in FIG. 19, the blueshift of the axial mode 81 is most pronounced, while the radial breathing mode shift 83 is smallest both in absolute (Δv) and relative terms (Δv/v). Treating the axial and breathing modes as harmonic oscillators with frequency, v=1/2π\sqrt{k_{ax(br)}/m}, where k_{ax(br)} is the spring constant, the estimated change in stiffness across the time series is Δkₐₓ=2.1×10³N/m and Δk_{int.}=4.7×10⁴N/m, where Δkₐₓ is the stiffness change for the axial mode and Δkᵢₙₜ is the internal stiffness change due to the radial breathing motion. These estimates are slight underestimations of the true values because the frequencies may also be influenced by changes in dephasing caused by the stronger adhesion force. If the equation of motion of a spring is considered with damping term c>0, mü(t)+c\dot{u}(t)+k_{int.}u(t)=0, where u(t) is the time-dependent displacement of the particle, the frequency is given by v=(1/2π){square root over ((kᵢₙₜ/m−(c/2m)²))}. The damping term, therefore, red shifts the frequency. Since both the axial and radial breathing modes are gradually narrowing, the term c must be decreasing with lab time. For example, the damping constant for the radial breathing mode decreases by 39% within 10 minutes. Additionally, the amplitudes of the axial mode, relative to the breathing and shearing modes, dramatically increase over the time series (note, the plots are shown on a normalized scale for clarity). The axial mode amplitude depends on the distance between the nanoparticle and the substrate as well as the amplitude of the breathing mode. When the particle is closer to the substrate, the breathing mode induces a larger axial amplitude vibration, consistent with the nanoparticle/substrate interaction increasing with experiment time.

It is noteworthy that the shearing modes are far stronger for the untethered particle than for the tethered particle, which is attributed to breaking the spherical symmetry near the substrate. Besides the axial modes, all the observed vibrations may be enumerated by the number of radial modes, n, and the angular momentum, l. The breathing mode is defined as n=l=0, while the shearing modes are non-spherically symmetric modes involving shearing strain. For a small spherical AuNP, the n=0, l=1 mode is not optically active. Therefore, the large number of modes observed in the FIG. 18 spectral series in the range 6-25 GHz, cannot be accounted for by considering only the Raman-active spherical harmonics angular modes, which suggests strong coupling between the axial, shearing, and breathing modes. For the two modes at 8.3-8.8 GHz and 18-18.5 GHz, the frequency shifts were nearly identical with time. The dephasing of these two modes also followed the same trend, whereby the dephasing rates remained largely unchanged. For the main axial mode and the shearing mode at 12.5-12.9 GHz, the dephasing rate decreased (i.e., exhibited a longer lifetime) with increased nanoparticle/substrate interaction, which is commensurate with an increase in the breathing mode lifetime. These correlations support the symmetry-breaking argument whereby the substrate interaction acts to couple the axial, shearing, and breathing modes by modulating the stiffness of the overall motion of the nanoparticle.

With a deeper understanding of how the different acoustic modes in the AuNP influence one another and their dependence on the particle/substrate interaction, the virus particles are next considered. Unlike the metal nanoparticles, the virus vibrations are not excited through the promotion of electrons to form hot carriers because the electronic transition of the molecules composing the virus, namely amino acids and nucleic acids, are in the ultraviolet spectral region (>4.4-4.8 eV). The pump pulse has only 1.2 eV of energy, by way of comparison. Resonant excitation of an electronic transition in the virion would require simultaneous absorption of at least four photons, which is highly improbable. Under this non-resonant condition, the excitation proceeds by stimulated Raman scattering, whereby Raman-active normal modes are excited on the electronic ground state. The vibrations of the virus result in a periodic change in the phase of the back scattered probe pulse centered at 1.58 eV, which is coherently mixed with the unaffected portion of the pulse in a heterodyne detection scheme.

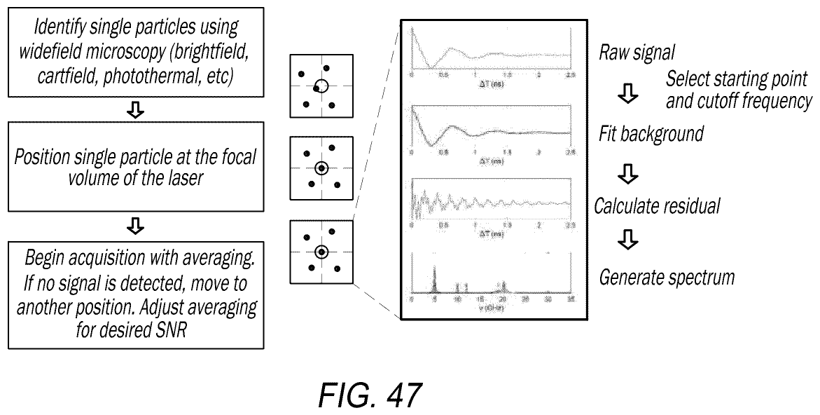

The signal strength is far weaker than a comparatively sized metal nanoparticle and the virion does not experience an appreciable temperature change during this process. The exceptionally weak signal necessitates the use of the ASOPS system rather than a lock-in amplifier based, step-by-step detection scheme to reduce noise along the inter-pulse time delay dimension. Further, balanced detection is used to eliminate contributions of the signal that do not arise from the virion itself, followed by a high-pass electronic filter that further eliminates sub-GHz signal contributions dominated by laser intensity noise and sample drift. Despite these efforts, the signal still employs an averaging of 100,000 scans at a 3 kHz offset (up to 33 seconds of averaging) to generate each spectrum shown herein, by way of nonlimiting example. Analysis of the SNR, averaging, time resolution, background subtraction, and other experimental and data processing methods are illustrated in FIG. 47.

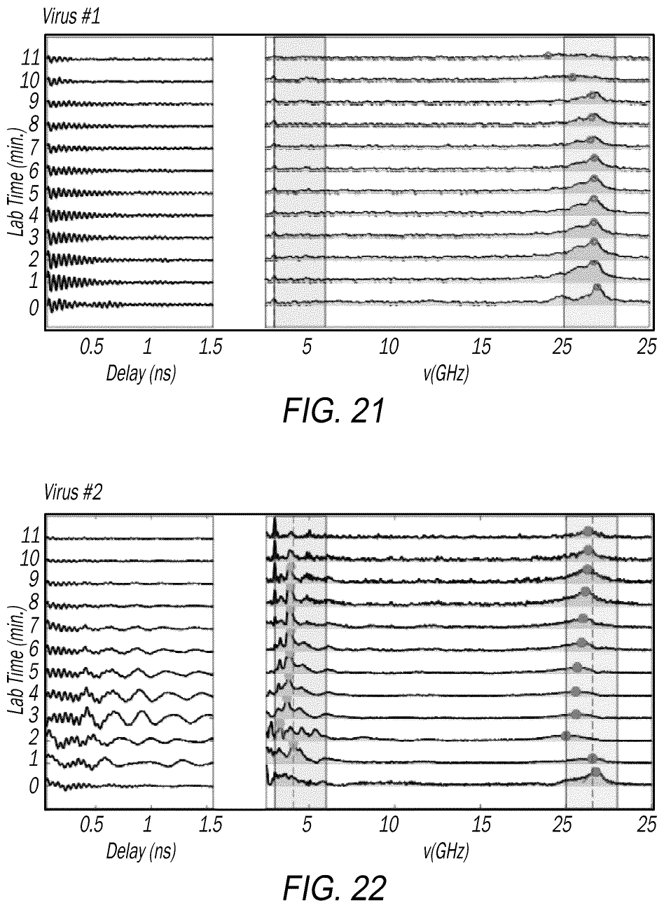

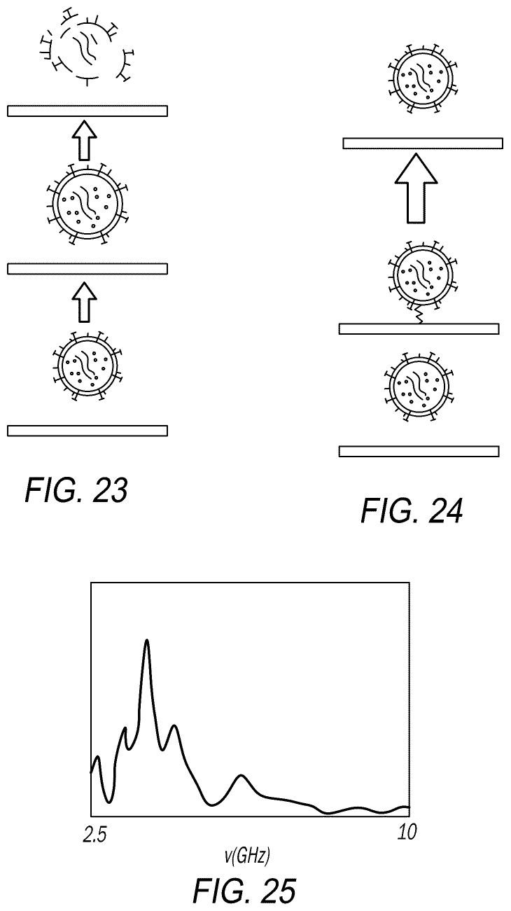

Two exemplary single particle trajectories are examined to illustrate the substrate effect on the acoustic spectra. FIG. 21 shows a series of single virion spectra in the 2-25 GHz spectral range collected over a span of 11 minutes. The spectra reveal a single breathing mode near 21.8 GHz, with a prominent shoulder red-shifted by 1-2 GHz. As with the nanoparticles, basic features of the acoustic spectra may be described by elastic continuum theory with boundary conditions at the surface of the virus particle.

For a particle with radius, R, using stress-free boundary conditions, the energy eigenvalues may be obtained for Lamb's equation of motion for a three-dimensional elastic body. These eigenvalues depend on the orbital angular momentum quantum number l, and harmonic n that describe surface modes for n=0 and inner modes for n≥1. Since the excitation process occurs through Raman scattering, selection rules dictate that only the spherical modes are allowed: l=0 corresponds to a purely radial mode with spherical symmetry, while l=2 is a quadrupolar mode. The estimated particle diameter is 72 nm for the lowest-order radial breathing mode (l=n=0) observed at ˜21.8 GHz, assuming that the longitudinal sound velocity in the virus is close to that of the lysozyme protein crystal (1817 m/s). Since the virus composition and density are not uniform, it is expected that the actual diameter of the virion is slightly larger which agrees with the estimated diameter of the enveloped Lenti virus of 80-100 nm. The next lowest allowed mode at l=2, n=0 for a spherical model virus occurs at 20.5 GHz, which is in very close agreement with the observed shoulder near 20.8 GHz.

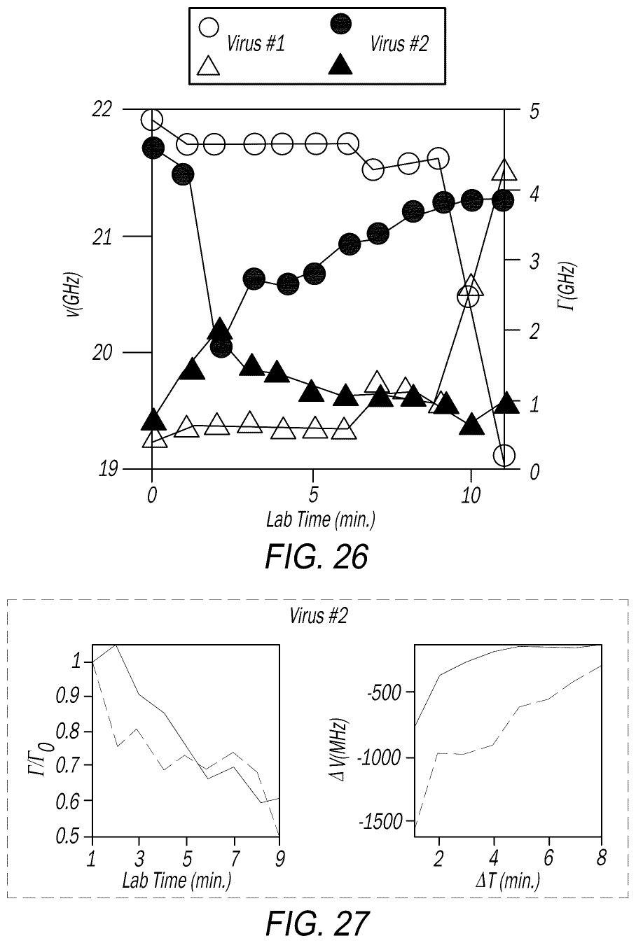

The notable absence of axial or shearing modes suggests that the virion is weakly or non-interacting with the substrate. The spectra remain largely unchanged until about 6 minutes, when the breathing mode begins to weaken and broaden. Then the mode exhibits a dramatic red shift and severe broadening at 10 minutes before the signal disappears below the noise floor. This red shift and broadening imply a softening of the phonon modes which occurs as the viral capsid begins to weaken, swell, and suddenly ruptures. While most virions measured stayed intact during the measurement and despite employing non-resonant excitation conditions, the virus particles occasionally ruptures after several minutes of laser exposure, possibly through multi-photon ionization or localized and excess thermal accumulation. Hence, the localized environment of each virion measured may be different due to material present after purification—buffer, impurities, and formaldehyde crystals remaining after virus deactivation. FIG. 26 shows that evolution of the frequency and dephasing rate in the breathing mode, which are anti-correlated with each other.

Referring to FIG. 22, a second virus particle is measured with the breathing mode and shoulder very similar to Virus #1 initially, but with a much stronger axial mode that grows over time. After about 1 minute, the breathing mode red shifted by a relatively large value of 1.5 GHz, broadening significantly. This is consistent with the damping model described earlier in which the red-shift of the breathing mode is correlated with increased broadening (see filled triangles and filled circles at 0-2 min. in FIG. 26). The large red shift of the breathing mode is due to changes in the virion/substrate interaction.

Measurements of LentiGFP virus on a mica substrate are recorded to further corroborate this substrate-mediated interaction, discovering that the breathing mode red shifts by ˜2 GHz compared to the fused silica substrate. At 2 minutes, a prominent axial mode appeared (see the small circles near the 2 GHz region) and started to blueshift as the adhesion force between the virion and substrate increased. As with the AuNP, the breathing mode experienced a blueshift, while both the axial and breathing line shapes narrowed, corresponding to increasing dephasing time.

Shearing modes appeared in the 5-10 GHz region, but were weak and difficult to quantify. Accordingly, correlations among the spectral features are considered to gain more insights into the coupling of these modes. As with the trajectory of the virus sample #1, the spectral shift of the breathing mode in the virus sample #2 was anti-correlated to the dephasing rate. Next, which axial modes most strongly coupled to the breathing modes is identified. For the peak marked in orange (2-3 GHz), both the axial and breathing mode increased their lifetime with lab time at nearly the same rate, while both experienced correlated spectral shifts at different relative magnitudes as is demonstrated in FIG. 27. Further, the axial modes show a far more complex pattern of peaks than in the case of AuNPs, which may be explained by the structure of the envelope proteins. The virion has the vesicular stomatitis virus G protein (VSV-G, 58.4 kDA without glycosalation) composing the envelope. These glycoproteins may be considered as a series of coupled oscillators whose interactions with the substrate are reflected in mode splitting much like that observed for the tethered AuNP.

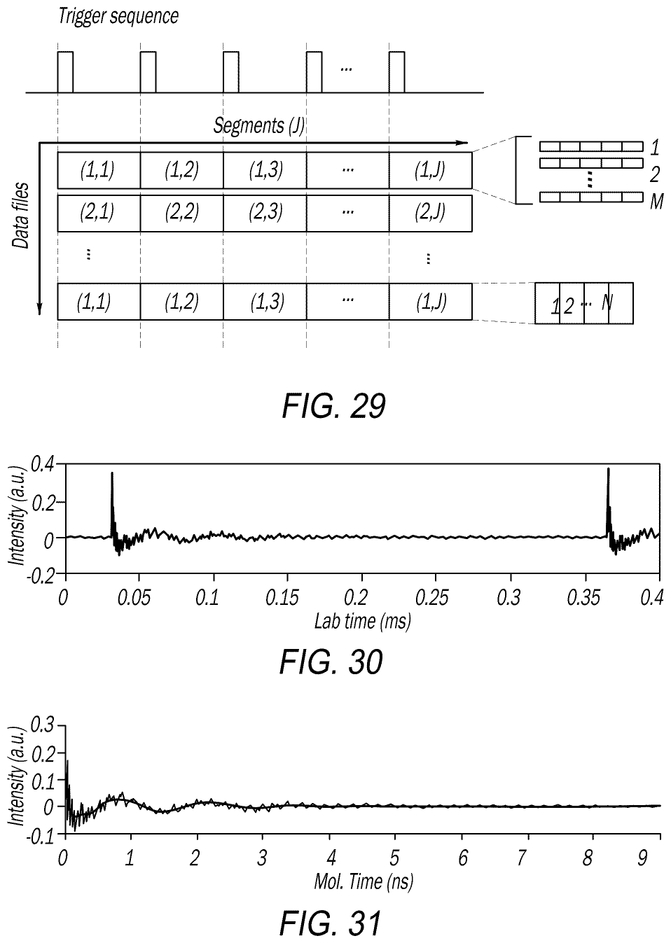

A first embodiment of the present spectroscopic bioagent detection apparatus 51 is shown in 46. Apparatus 51 generally includes an asynchronous optical sampling laser system 99, an optical trigger generation system, a correlative microscope 57, a balanced detector 101, detection electronics, and a high-speed digitizer 103. The trigger sequence and data structure are represented in FIG. 29. These sub-systems are described in detail as follows.

Asynchronous optical sampling laser system (ASOPS) 99 includes three components: pump laser 59, probe laser 61, and repetition rate electronics (RRE) 105. A pump laser beam light 107 is delivered by ASOPS 99 with an exemplary central wavelength of 1040 nm, output power of 1 W, pulse duration of 100 fs, and a repetition rate fᵣ=100 MHz. Furthermore, a probe laser beam light 109 has an exemplary central wavelength of 785 nm, 100 mW output power, 100 fs pulse duration, and a repetition rate equal to fᵣ+Δf, where Δf is a small offset (typically 3 kHz). RRE 105 allows for synchronization between the lasers. ASOPS can be obtained from Menlo Systems GmbH in an exemplary configuration.

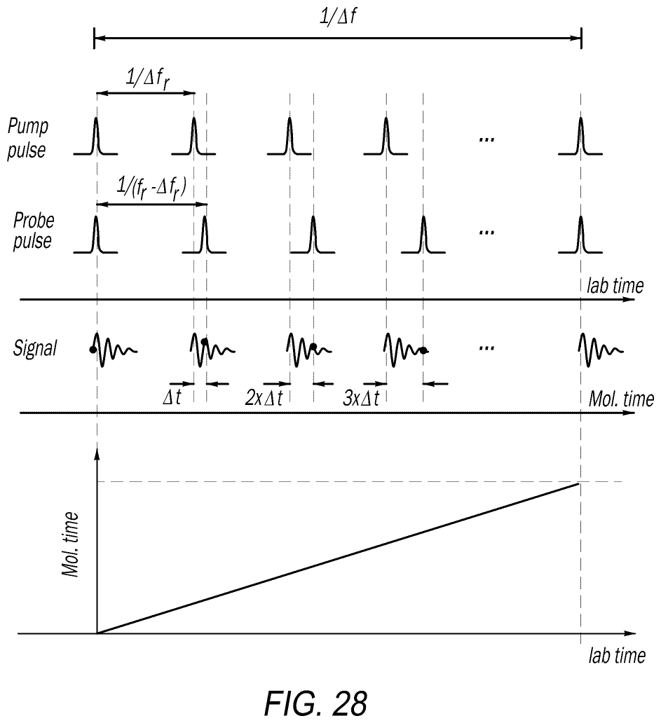

Reference should now be made to FIG. 28 where the scanning principle of the ASOPS emits laser light pulse trains to scan in time with respect at a rate given by Δf. The offset value also sets the scan period to 1/Δf, while the maximum measurement window is the pulse train interval 1/fᵣ. At 100 MHz repetition rate, the measurement window is 10 ns. The time delay in the molecular time is the difference between the pulse periods of the two laser pulse trains 1/(fᵣ−Δf)−1/fᵣ, which is simplified as Δf/fᵣ² under the assumption that Δf«fᵣ. Since the scan is linear and periodic, a GHz to THz frequency of a molecular vibration is down converted to a kHz to MHz digitization frequency in lab time. The down-conversion factor is fᵣ/Δf. For example, if the offset is 1 kHz and the measurement window is fixed as 10 ns, the scanning period is 1 ms in real time, the scanning resolution is 100 fs, and the down-conversion factor is 1 kHz/100 MHz=1×10⁻⁵. In this case, a 1 THz vibrational frequency is down converted to 10 MHz, while a 1 GHz vibration corresponds to 10 KHz.

The signal detection system employs balanced detector 101 and electronic signal conditioning. More specifically, when a flip mirror is down, the 785 nm probe laser beam is routed by a mirror 121, and focused to one receiving channel of a balanced, amplified detector (such as model PDB210A from Thorlabs, Inc.). The other channel of the balanced detector receives a reference optical signal, which is achieved by splitting ˜10% of probe beam 109 before it reaches the microscope, using a plate beam splitter 123 (such as model BSN10R from Thorlabs, Inc.). A set of short pass filters 125 (such as model FESH0900 from Thorlabs, Inc.) and iris apertures are utilized to block pump beams and stray lights, respectively. Note that fixed-value neutral density filters are used to attenuate the reference signal, while a cage-compatible, variable neutral density filter wheel 127 (such as model NDM2 from Thorlabs, Inc.) is used for fine tuning. After displaying and balancing outputs from the two channels in an oscilloscope 129, the difference current is converted to a voltage signal and magnified by an internal trans-impedance amplifier 131 inside balanced detector 101. The transimpedance gain is ˜10⁵ V/A, as a nonlimiting example.

Electronic signal conditioning is next explained. An output analog signal from balanced detector 101 undergoes the following signal conditioning steps: First, a DC block electric filter (such as model EF599 from Thorlabs, Inc.) and a high pass electric filter 141 (such as model EF115 from Thorlabs, Inc., having a >5 kHz passband, are coaxially connected to an RF output end of the balanced detector, blocking low-frequency noise.

Second, a wideband preamplifier (such as model SR445A from Stanford Research Systems) provides further signal magnification. Depending on signal amplitude levels, up to 1000× amplification is attainable by cascading amplifier channels. Another DC block electric filter can be used after the pre-amplifier to further block the DC offset.

Digitization, on-board averaging, such as data acquisition and logging, are performed using software instructions, stored in non-transient RAM or ROM memory and run by a microprocessor of a programmable controller computer 145. To avoid acquiring a large amount of data in the single record mode, multiple record mode and the on-board averaging function are used to visualize raw data, ease data manipulation, and reduce data size. Data is acquired and organized into a number of record segments (J) upon probing a rising-edge trigger event with a rate of a few kHz. Typically, J=100 multiple record segments, which are recorded, and each contains N data points. Data points N include two time zero ‘spikes’ to encompass a complete scanning period; for example, N=6000 may be selected with a 10 M Sa/s sample rate. On-board averaging number M=1000 is used to reduce data size by 3 orders of magnitude, which is done in the digitizer memory. Tens of data files (I) are saved in the controller's hard drive for further averaging and time-evolution analyses. Therefore, the total number of signal averaging is J×M×I, and the total data points saved in PC is N×J×I. Representative data averaging number, data file size, and data acquisition time are 1 million, 6 megabytes, and 1 minute, respectively. Programmable controller 145 includes an input such as a keyboard and/or communications receiver, and an output such as a display screen and/or a communications transmitter. In an optional configuration, the software instructions employed with the present method and apparatus may be run on one or more connected controllers, which may be adjacent to or remote from each other.

Microscope system 57 has a microscope frame (such as model RM21 from Mad City Labs). 1040 nm pump laser beam 107 is steered by a silver mirror 147 and a dielectric mirror 149 to a bottom reflective objective lens 151 (such as a 74×/0.65 lens from Beck Optronic Solutions), and then focused to a diffraction-limited spot (˜1 μm) in a sample plane. From the top, 785 nm probe laser pulse 109 is guided by mirrors 161 and 163 to a high numeric aperture objective lens 165 (such as a 100×/0.9 lens from MPlanFL N, Olympus), which focuses the probe beam to ˜1 μm spot. Diameters of both laser beams are also expanded to slightly overfill the objective lens.

A half wave plate 171 and a quarter wave plate 173 are used to convert linear polarization to circular polarization for both laser beams. Furthermore, the back-reflected 785 nm laser beam 109 from the sample changes back to a linearly polarized one and is 90° shifted with respect to the incident beam towards the sample. Polarizing beam splitter cube 123 (such as model CCM1-PBS252 from Thorlabs) is placed in the probe path, transmitting most incident probe power and reflecting most back-scattered probe power to detector 101.

To observe and image nanoparticle samples, a blue LED light source 175 (such as model M490L4 from Thorlabs) is collimated by a condenser lens 177 and coupled to top objective 165 by a dichroic mirror 179 with a long pass cutoff at 506 nm (such as model 67-080 from Edmund Optics). A small portion of the back-scattering light passes through dichroic mirror 179, reflected by another long pass dichroic mirror 181 (such as Semrock model FF700-Di01-25×36), and forms images by an achomatic lens 183 having focal length=150 mm, in a CMOS monochrome camera 185 (such as Blackfly model BFS-U3-51S5M). Optionally, a white light LED (such as model MWWHL4 from Thorlabs) can be placed below bottom objective 151, used for imaging in the transmissive mode. In addition, sample particles and the probe beam profile are imaged after a lens 187 with a focal length=175 mm, and then relayed by a 4-f lens system consisting of lenses 189, 191 and 193 with an identical focal length 200 mm, to a 100 μm pinhole 195. The spatially filtered light is imaged by an sCMOS camera 197 (such as Andor model Zyla 5.5) via a flip mirror 199 and an achromatic lens 193 having a focal length=100 mm.

Additional optical components include mirrors 221, beam splitters 223, half wave plates 225, quarter wave plates 227, lenses 229 and a dichroic mirror 231. Also present are photodiodes 251, a beta barium oxide (BBO) device 253, a filter 255, a comparator 257 and a delay generator 259. Comparator 257, delay generator 259 and their associated optics are part of an optical trigger generation system, which are connected to an external trigger 261. A frequency divider 263 is connected to an external clock 265. Trigger 261 and clock 265 are connected to a digitizing on-board averaging circuit which is part of a programmable controller 271, to which wideband amplifier 143 is also connected.

Functionally, the asynchronous optical sampling generates two pulse trains with a fixed repetition rate offset. The pump pulse is directed towards the sample from one side while the probe pulse is directed from the opposite side. The probe pulse is split prior to the sample and serves as a reference for balanced detection. Moreover, the probe light scattered from the sample in an epi configuration is directed to the other arm of the balanced detector. The signal is then amplified and sent to a high-speed digitizer whose clock is set by the repetition rate electronics (RRE) and triggered by the offset either generated from the RRE electronically or through an optical trigger generation system.

Background subtraction is next discussed with reference to FIGS. 30-34. The raw signal is acquired by the digitizer of the programmable controller. At a 3 kHz offset, each scan completes in 0.333 ms, such that for a 4000 pt acquisition at 10 M/s, 0.400 ms of data are acquired, thereby revealing part of the next. This 20% overhead ensures that all the data is acquired and that the signal repeats exactly after each scan. The spike in the data corresponds nominally to time ‘zero’ where the two pulse trains overlap in time. Although the exact position of the pulse overlap is hard to determine, the frequency spectrum is unaffected by the exact time zero position.

The signal exhibits complex time-domain oscillations which are a combination of two dominant effects: 1) the electronic conditioning which filters the signal using a high-pass electronic filter and a low-pass balanced detector, 2) the Raman signal arising from the acoustic vibrations of the nanoparticle including the axial, shearing, and breathing modes. The first effect, primarily the presence of the high-pass filter, causes a large distortion in the signal that is corrected. This filter is used because the low-frequency components of the signal generated from the balanced detector swamp the small, coherent oscillations that encode the acoustic response. However, Fourier transforming the signal after the high-pass electronic filter buries the desired signal components. Accordingly, a Bayesian inference approach removes the effects of the filter, although other filters such as Fourier filters may alternately be employed. For a 22 kHz high-pass filter, the expected frequency in the molecular frame is v_{HP}=22 kHz/α, where α=δf/fᵣ=3×10⁻⁵ is the down-conversion factor. This gives v_{HP}=0.73 GHz, which is still well below the expected acoustic frequencies of interest.

In the Bayesian method, the entire signal is fit to a sum of exponentially decaying sinusoidal model functions, gᵢ(t)=cos(ωᵢt+ϕᵢ)exp(−Γᵢt) in an iterative manner. Unlike many other nonlinear fitting methods, the amplitudes of the model functions are not directly fit, but rather treated as nuisance parameters using a variable projection approach. The nonlinear fitting algorithm uses a combination of local and global search methods, which are accelerated by explicitly calculating the Jacobian and Hessian of the model functions. The algorithm finds the set of parameters, Φ=[ω, ϕ, Γ], to minimize Q(Φ)≡|S(t)−M(Φ, t)B|², where S(t) is the signal, M(Φ, t) contains the model functions as columns, and B is a column vector of the amplitudes. The iterative algorithm terminates when the standard deviation of the residual between the signal and the fit is at or below the estimated standard deviation of the noise.

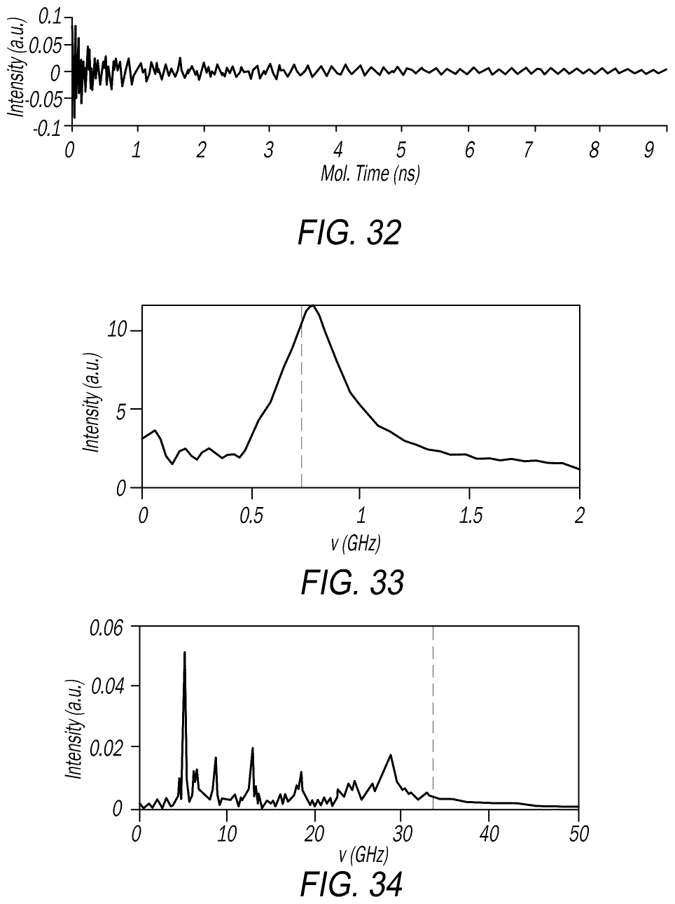

While this approach may be used to fit all signal components, here it is only used to remove the background signals below a prescribed cutoff frequency. For the signal shown in 31, v_{cut}=2.5 GHz. The reconstructed fit for components with frequencies below the cutoff are shown as a smooth line around the middle of the peaks and valleys, and the residual after subtracting the low-frequency signal is shown in FIG. 32. This signal, therefore, represents all the components with frequencies above the cutoff.

FIG. 33 depicts the background subtraction method recovering the effects of the filter and FIG. 34 illustrates the desired Raman signal. To eliminate pulse-overlap effects and early-time dynamics from the spectrum, the analysis starts after 30 ps, which slightly degrades the spectral resolution of the breathing mode (by ˜5-10%) and has negligible effect on the axial modes (<1%). Note that the amplitude of the low-frequency components is ˜200× that of the largest amplitude observed in the acoustic spectrum (near 5.2 GHz) and >670× that of the breathing mode amplitude (near 28 GHz).

More specifically, for the 100 nm AuNP background subtraction procedure, FIG. 30 shows an original signal from the digitizer, while FIG. 31 illustrates the signal in the molecular frame and the low-frequency component of the fit. Also, FIG. 32 depicts a residual of the signal and its low-frequency fit. Then, FIG. 33 shows a FFT of the low-frequency fit (where dashed line shows the expected center frequency of the high-pass filter at 22 kHz), and FIG. 34 graphs a FFT of the residual showing the acoustic modes, with a dashed line showing the expected cut-off frequency from the balanced photodiode.

There is also a low-pass filter that must be accounted for in the analysis, but its effect is much smaller. This filter is due to the limited bandwidth of the balanced detectors used here of 1 MHz, which in the molecular frame, corresponds to a frequency of v_{LP}=1 MHz/α=33.33 GHz. Therefore, no signals greater than this frequency are detected even if the bandwidth of the pulses support up to ˜2 THz. Using a higher bandwidth detector or a lower offset frequency would allow a wider range of acoustic frequencies to be detected. For instance, for a 10 MHz bandwidth detector and a 1 kHz offset, signals as high as 1 THz could be detected.

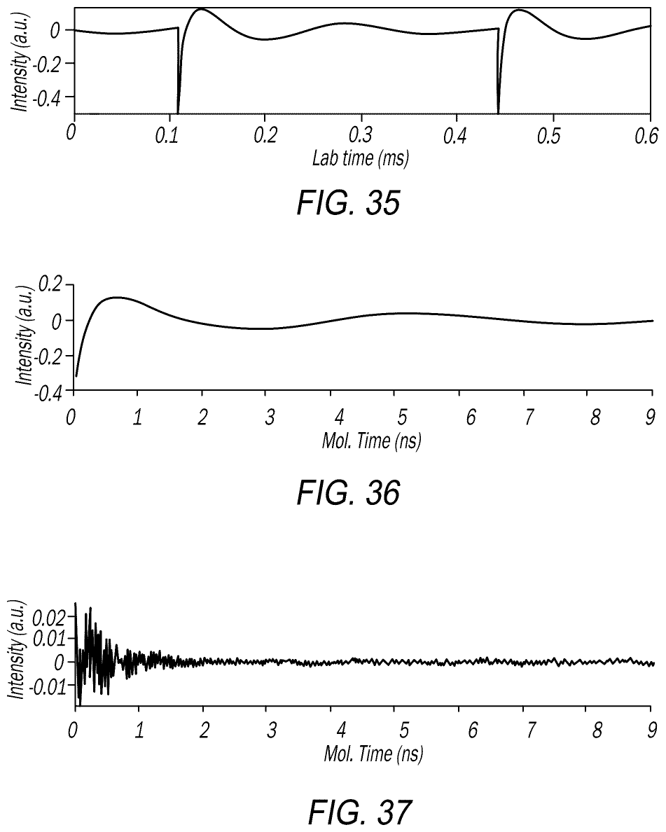

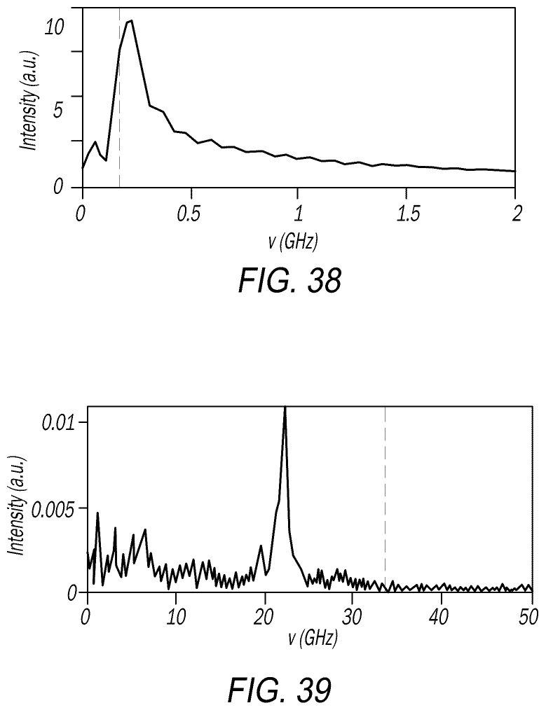

The same analysis applied to one of the trajectories for a single Lentivirus is shown in FIGS. 35-39. Note that a 5 kHz high-pass electronic filter is used, but all other parameters remained the same. More specifically, in the LentiGFP background subtraction procedure, FIG. 35 shows an original signal from digitizer, FIG. 36 shows a signal in the molecular frame and low-frequency component of the fit, while FIG. 37 illustrates a residual of the signal and its low-frequency fit. Meanwhile FIG. 38 represents a FFT of the low-frequency fit (with the dashed line showing the expected center frequency of the high-pass filter at 5 kHz). FIG. 39 depicts a FFT of the residual showing the acoustic modes where the dashed line shows the expected cut-off frequency from the balanced photodiode.

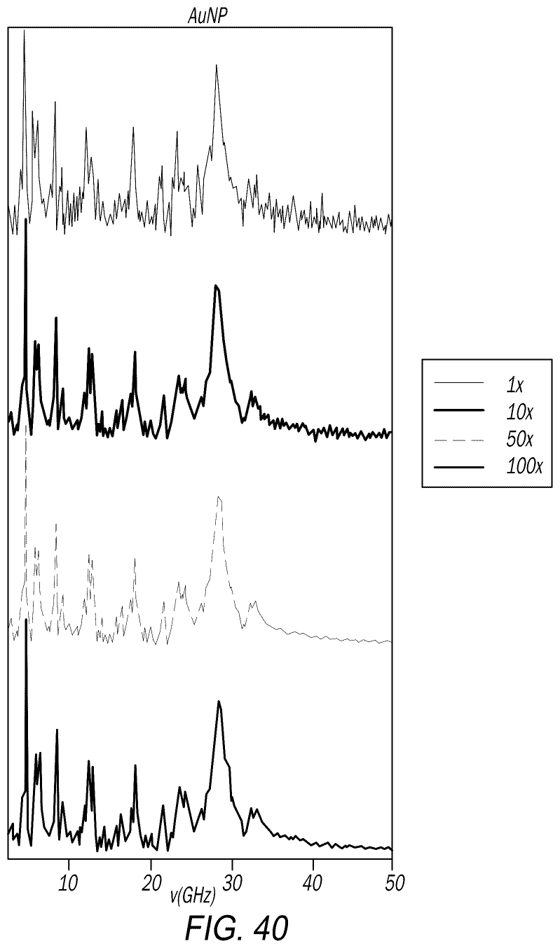

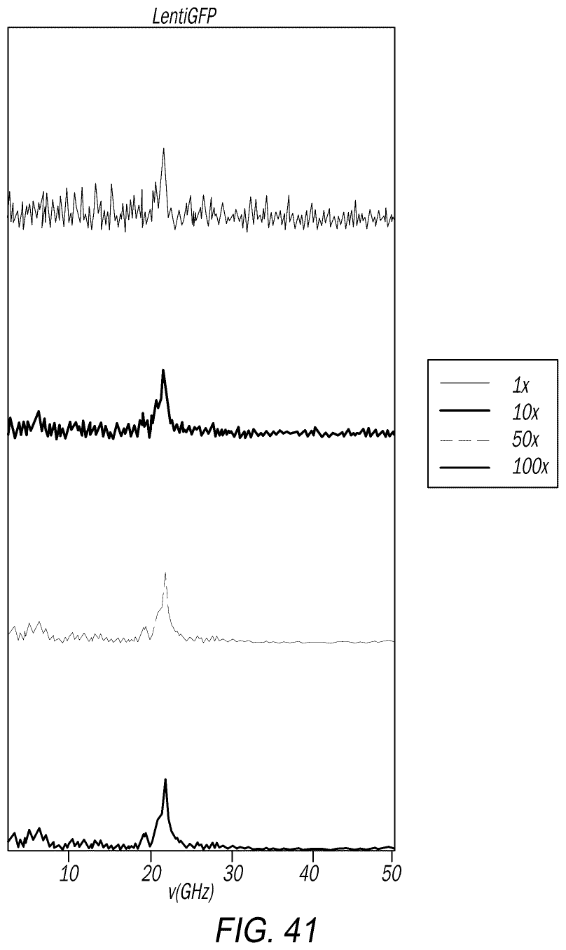

The signal-to-noise and time resolution aspects of the present method and apparatus are now set forth. The trajectories are displayed in increments of 1 minute, but the time resolution of the measurement may be higher depending on the signal-to-noise (SNR) ratio. Since the digitizer performs 1000 on-board averages, each measured trace corresponds to 0.33 seconds of acquisition time. Therefore, only about 80% of the signal is used in the analysis, so that each trace shown corresponds to ˜0.25 seconds of acquisition. For AuNP, the signal is sufficiently strong that one trace (x1) generates high SNR >10, as can be observed in FIG. 40. The on-board averaging may be reduced further in this case to enable millisecond acquisition times. For the viruses, however, the SNR is significantly weaker as is shown in shown in FIG. 41 (applying the same analysis to a single virus particle). Here, at least 10 trace averages (10,000 total averages) are needed for and SNR >10 for the breathing mode, while the axial mode rises above the noise floor. At this level of averaging, the time resolution is ˜2.5 seconds, and if only the breathing mode is required, the time resolution may be as low as 0.25 seconds.

The AuNP sample preparation is as follows. Glass slides with 22×60 mm size are ultrasonically cleaned in 1 M sodium hydroxide (NaOH) solution, Milli-Q water, and ethanol for 30 min, respectively. The glass slides are immersed in piranha solution (H₂SO₄:H₂O₂, 5:1) for 10 min to decorate the glass substrate with hydroxyl groups (OH⁻). The glass slides are then incubated in 5% (V/V) (3-aminopropyl) triethoxysilane (APTES) in ethanol for 3 h. After 3 hours, the cover glass are dried under N₂ stream and the slides are then subjected to thermal annealing in a vacuum oven at 110° C. for 2 hours to obtain APTES-silanized slides with amine groups, which are subsequently immersed into the AuNPs solution for 6 h adsorption. The amino groups on the APTES molecules are used to immobilize gold particles onto the substrate due to the specific affinity of the amino group to the colloidal gold nanoparticles. After the Au NP adsorption, the glass slides are washed and dried under N₂ stream.

The virus sample preparation is as follows. Lentivirus is produced in 293FT cells by transfecting with 2^{nd} generation lentiviral plasmids. Virus is grown for 72 hours, and then supernatant collected and filter 0.45 μm filter to remove cellular debris. Once filtered, the virus sample is concentrated by spinning in an ultracentrifuge at 20000 RPM for 2 hours. The supernatant is poured off and pelleted virus is then resuspended with 4% paraformaldehyde for 16-18 hr to inactivate the virus.

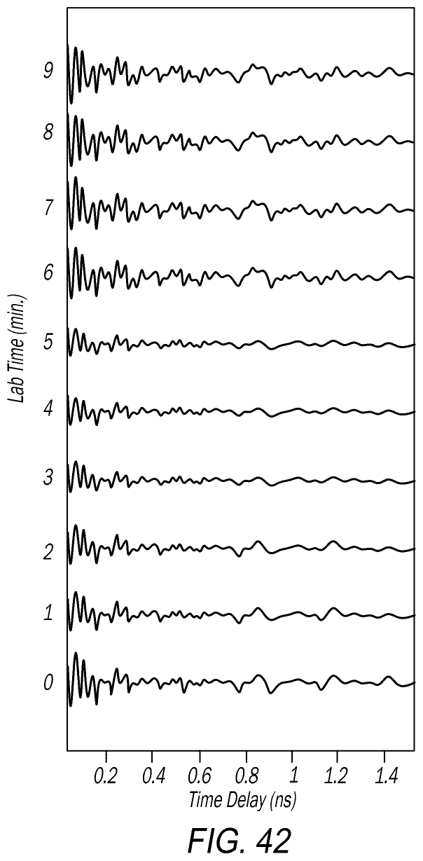

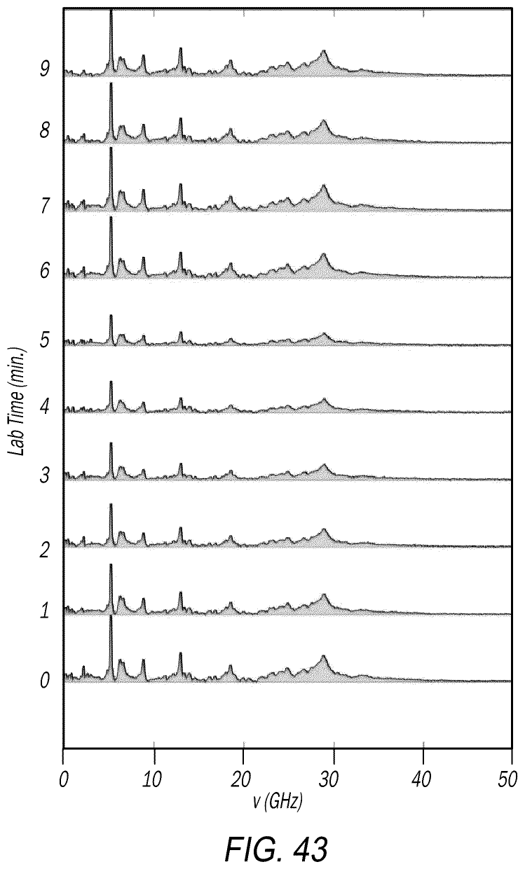

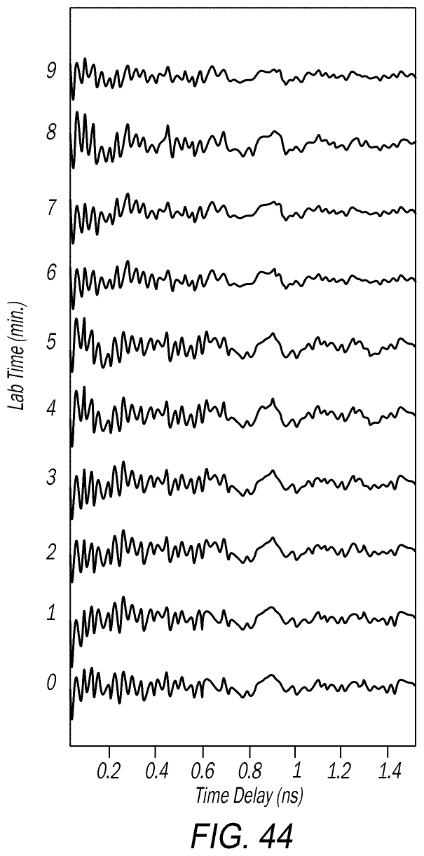

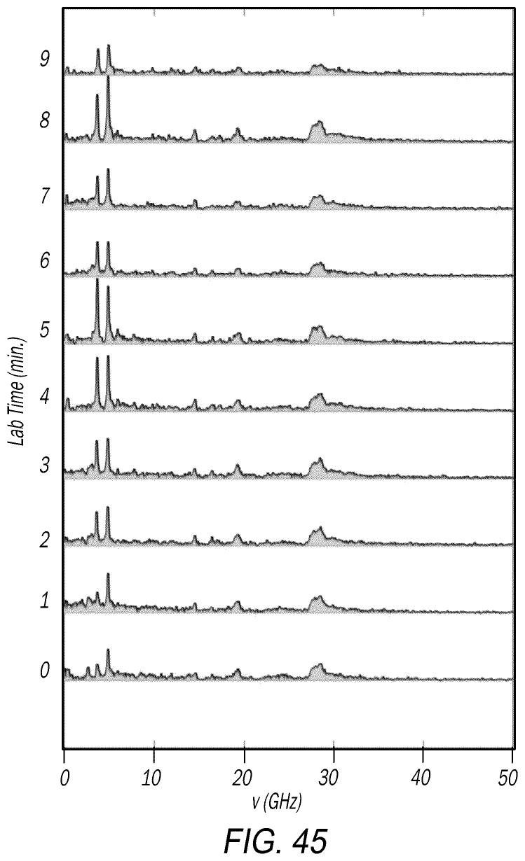

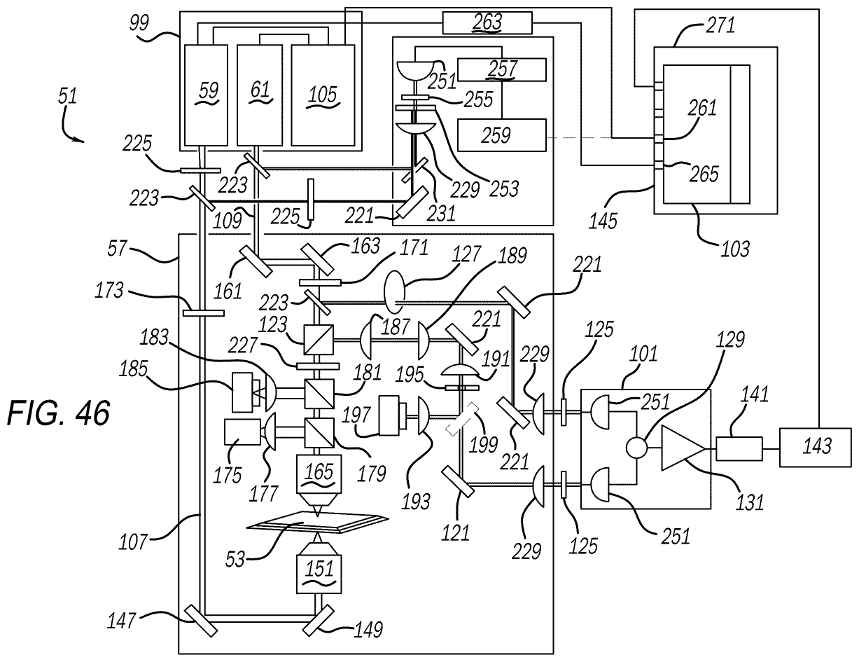

FIGS. 42 and 43 depict two additional AuNP trajectories that show similar acoustic spectra. The trajectory for an untethered, single 100 nm AuNP displays similar spectral features to those in FIG. 18. The trajectory for a tethered, single 100 nm AuNP of FIGS. 44 and 45 exhibits similar spectral features to those shown in FIG. 13. Note, the extent of spectral shifting is highly dependent on the particle environment. While the breathing mode for each AuNP measured was around 28 GHz, the line shapes differed significantly, which is due to different factors such as the presence of multiple crystalline domains, deviations from spherical symmetry, and matrix effects.

Use applications of the present single bioagent detection are now discussed. First, clinical identification of viruses relies on the detection of viral proteins or viral nucleic acids. For the latter, PCR amplifies the signal due to the low content of viral nucleic acid. For antigen rapid tests, the amount of viral protein needed is large and the virions are pre-treated for detection. Further, residual viral RNA from patients may be detected (false positives) even though they have recovered. In other words, these methods detect viral fragment rather than intact virions. Additional or alternate, optional uses of the present method and apparatus include:
a. Detection of intact virions in human saliva, and undiluted fetal bovine serum.
b. Compositional analysis of single viruses for viral vectors used in gene therapy.
c. Medical Diagnostics: Early detection of viral infections at the individual virus level, which is important for timely intervention, potentially reducing the severity and spread of viral infections.
d. Vaccine Development: Understanding how individual viruses interact with cells can aid in vaccine development. Researchers can design vaccines that target specific stages of the virus life cycle.
e. Viral Load Monitoring: Assess the effectiveness of treatment and therapy by monitoring virus loads.
f. Identification of new viral strains.
g. Drug development: Facilitate the development of antiviral drugs by observing how viruses react to drugs (e.g. mechanism of drug resistance).
h. Detection of viruses in environmental samples to monitor potential outbreaks and understand environmental transmission routes.
i. Food Safety: Detect viruses that cause foodborne illnesses.
j. Early warning system against bioterrorism or accidental releases of dangerous pathogens.
k. Structural quality control of biologics and vaccines: assess batch-to-batch structural consistency of viral vectors, virus-like particles (VLPs), or nanoparticle-based vaccines.
l. Real-Time tracking of viral assembly and disassembly in bioreactors: inline monitoring of virus production during biomanufacturing.
m. Acoustic “Barcode” labeling for multi-agent therapeutics: Engineer viral vectors or nanoparticles with distinct acoustic fingerprints for simultaneous delivery of multiple payloads (akin to fluorescence barcoding).
n. High-throughput viral phenotyping for personalized medicine: Measures mechanical/structural properties of virus particles isolated from a specific patient (e.g., from blood, saliva, or tissue). This can advantageously help predict whether a patient will likely respond to a particular antiviral drug.
o. Smart surfaces or biosensors: Integrate BioSonic detection with lab-on-a-chip platforms for point-of-care or wearable biosensors. Note, this employs miniaturizing the system such as by placing a laser on a semiconductor, silicon microchip.
p. Environmental and Industrial Virology: Continuous detection of viruses in industrial fermentation or wastewater treatment.
q. Detect biological weapons that have been released in the atmosphere: This would employ the present method and hardware as a remote, standoff BioSonic detection system. The laser could be directed from the ground, at a far distance, and then the backscattered light would be detected.

Second, similar applications of the present method and apparatus can be used for detection of single bacterium:
a. Studying how individual bacteria respond to antibiotics to understand antibiotic resistance.
b. Infection control in healthcare: preventing spread of harmful bacteria in hospitals.
c. Monitoring bacteria in water, soil, and air.
d. Food safety (same as above).
e. Understanding and manipulating microbial processes for areas such as biofuel production, waste treatment, and synthetic biology.
f. Detection of harmful bacteria in crops and soil in managing plant diseases.
g. Water treatment and quality: monitoring bacteria in water treatment facilities.
h. Distinguishing bacterial from viral infections is crucial for medical diagnosis and treatment, public health management, vaccine development, antimicrobial development, agriculture and food safety, and environmental monitoring/Third,

using the present method and apparatus allows for differentiating cells based on their mechanical properties (also, including differences in their size, shape, and volume) for the following use applications including: Blood analyzers to evaluate blood samples by 1) collecting a small amount of blood from a patient (mixing it with a anticoagulant), 2) loading the sample into the analyzer, 3) using cell counting and differentiation methods to count cell types in the blood. The latter involves either electrical impedance measurements (cells are passed through a small aperture which interrupts and electrical current), flow cytometry (cells are stained with fluorescent dyes), or optical methods based on light scattering and absorption. Blood analyzers also make hemoglobin measurements using spectroscopic methods that detect the iron containing proteins.

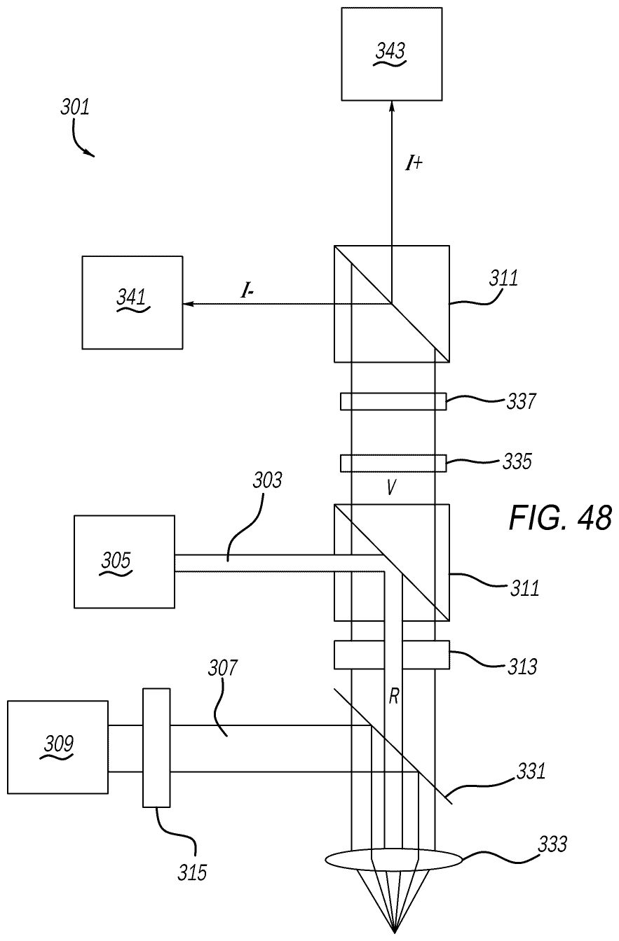

Software data flow used in any of the embodiments of the present apparatus 301 can be observed in FIG. 48 where, instead of using an external reference beam for the balanced detector as with the prior configuration, the present embodiment employs an internal reference based on polarization. The signal due to a pump light 303 emitted from a pump laser 305 imparts a different signal to two orthogonal components of a probe light 307 emitted from a probe laser 309. Polarizing beam splitter cubes 311, a quarter wave plate 313, a half wave plate 315, a dichroic mirror 331 and a focusing objective lens 333 are also used. An additional half wave plate 335 (22.5 degrees) and a 45 degree compensator 337 (phi) are also provided.

Photodiode detectors 341 and 343 detect these beam components and subtract them on a balanced photodiode. This is a type of phase-stable interferometer because both components of the probe pass through the exact same optics. Then by manipulating the relative polarization between the pump and probe and using compensator 337 (such as a Soleil-Babinet compensator or other zero-order phase compensator), the quantity of the signal imparted to each polarization component can be controlled.

Note, λ/4 optic 313 can be replaced with a Faraday rotator (not shown) to couple the probe into and out of the system. The difference is that with the latter, linear polarization of the probe may be provided. Accordingly, polarization is used to do the balancing, which greatly simplifies the setup and makes it far more stable, while allowing for more information to be extracted.

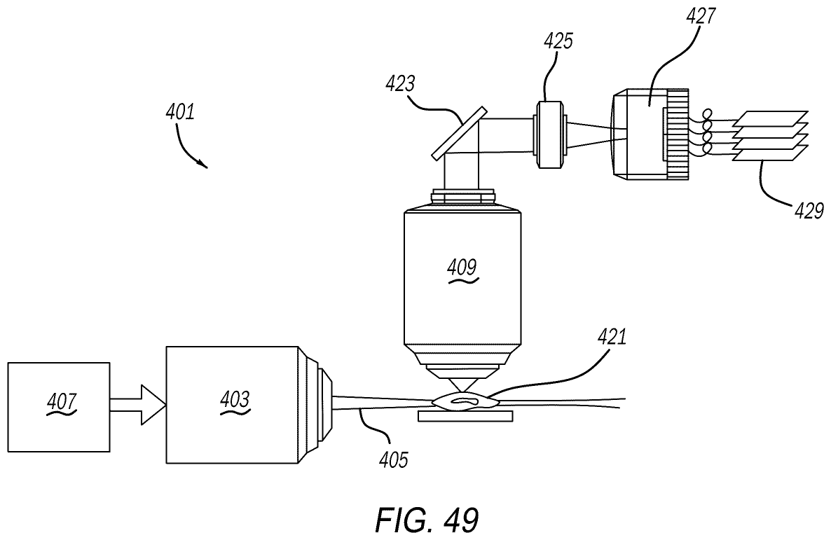

FIG. 49 illustrates another implementation which uses a light sheet geometry, to make the present imaging compatible with tissue type samples. This approach beneficially uses widefield illumination via a light sheet, which greatly speeds up acquisition and allows the system to capture all of the image information at once rather than via scanning. The present apparatus 401 excites and detects using two different objectives. An excitation objective lens 403 generates a light sheet 405 from at least one laser 407, and a detection objective lens 409 collects the light scattered from target specimen material 421 inside of this light sheet. The reflected light from detection objective 409 is reflected off of a mirror 423, sent through a tube lens 425, and received by a high speed detection camera 427. Frame grabbers 429 are connected to camera 427 and a programmable controller is also connected thereto. This is useful for thick samples where it is desired to reject signals away from the focus, and so volume imaging can be conducted by scanning the light sheet vertically (or scanning the sample), to achieve widefield imaging.

In conclusion, the acoustic phonon spectra of individual virions are measured by ultrafast spectroscopy. In contrast to traditional optical spectroscopic measurements of local bond vibrations or local electronic transitions, the present acoustic spectra are a measure of the collective oscillations of all the atoms that compose the virion. The nanosecond lifetimes of these collective vibrations impart to them a remarkable sensitivity to the virion shape and morphology as well as to the identity of its envelope proteins.

Furthermore, the ability to detect single, unlabeled virions without physical contact enables a long list of applications from ultra-sensitive viral detection to fundamental studies of virus dynamics including self-assembly and infection. The present method has sufficient time resolution to examine a single virion through its life cycle: attachment, penetration, uncoating, gene expression, replication, assembly and release, which occur on a seconds time scale. The large background of cellular material whose natural frequencies occur well below 1 GHz may be distinguished from that of the virion by exploiting the spectrally isolated acoustic spectra of the virion in the 2-30 GHz range.

As the axial mode of the phonon spectrum is sensitive to interactions of the envelope proteins with its environment, it should be possible to detect and quantify virion attachment to cells. The breathing mode, on the other hand, is sensitive to the virus mass, shape, and morphology, which will change as the virion genome is unpacked. While the discussion hereinabove focuses on viruses, the broad spectral range of the present method and apparatus is applicable to other microorganisms including bacteria and fungi, smaller nanoscale molecular machines such as molecular motors, and large proteins. The present approach provides a comprehensive understanding of biological processes by correlating both static structures and dynamics.

While various embodiments of the present method and apparatus have been disclosed, it should also be appreciated that other variations may be employed. For example, additional or alternate optics may be included in the present setup, however, many of the performance advantages may not be achieved. It is alternately envisioned that alternate types of lasers and electric components may be utilized, although some of the preferred advantages may not be realized. Furthermore, additional or fewer processing steps can be used, although some benefits may not be obtained. It should also be appreciated that any of the preceding embodiments and features thereof can be mixed and matched with any of the others in any combination depending upon the final product and processing characteristics desired. Variations are not to be regarded as a departure from the present disclosure, and all such modifications are intended to be included within the scope and spirit of the present invention.

The invention claimed is:

1. A method of spectroscopic bioagent detection, the method comprising:
(a) immobilizing a target particle, the target particle comprising a virus, bacterium or fungus;
(b) positioning the target particle at a focal point or light volume of a laser;
(c) optically vibrating the target particle with light from the laser, without use of a mechanical resonator;
(d) spectroscopically detecting a vibrational frequency spectrum from the vibrated target particle;
(e) automatically comparing the spectrum to a predetermined database stored in memory with a programmable controller;
(f) optically identifying the target particle with microscopy and the programmable controller; and
(g) automatically determining a characteristic of the target particle with the programmable controller, the characteristic comprising at least one of: a size, shape, loading, intactness or activity of the target particle, or surface proteins on the target particle.

2. The method of claim 1, wherein the detecting comprises measuring collective and coherent vibrations of a virion from the target particle in a −0.1-2000 GHz frequency range.

3. The method of claim 1, further comprising:
(a) operating across a 100 MHz to 100 THz frequency range to detect and identify the target particle even when its characteristics and type are unknown before commencing;
(b) cutting-off or filtering of undesired background noise signals, including at least one of: a live cell to which a virus is attached, blood or debris;
wherein the cutting-off or filtering includes at least one of: (i) using a physical mask to block out low spatial frequency photons, or (ii) using an electronic filter that blocks low-frequency components of signals generated from photodetectors; and
(c) magnifying a sensed vibrational characteristics of the target particle.

4. The method of claim 1, further comprising spatially mapping real-time imaging of a life cycle of the target particle, which is the virus, including at least one of:
attachment to, entry into, transport in, assembly to and release from, a live host cell.

5. The method of claim 1, further comprising using imaging to assist in identifying a target for a molecule inhibitor drug to block entry, replication or release of the target particle from a live host cell.

6. The method of claim 1, further comprising measuring coherent vibrational motion in a single virion of the target particle under ambient conditions as part of the detecting step, and using pump-probe pulses focused on the target particle as part of the vibrating step.

7. The method of claim 1, further comprising localizing ultrasonic motion in a virion of the target particle, and dephasing coherent motion therein in less 10 nanoseconds or less, to generate high spectral resolution to distinguish the ultrasonic spectrum of different virions.

8. The method of claim 1, further comprising detecting single virus sensitivity while distinguishing between the virus and background molecules.

9. The method of claim 1, further comprising identifying whether a virion of the target particle is intact, and distinguishing viruses with similar morphologies.

10. The method of claim 1, further comprising:
measuring the spectrum at each imaging pixel across a wide field of view which encompasses a live cell;
using single-pixel imaging in which probe light is spatially modulated using a digital micromirror;
scanning near video frame rates of at least 10,000 spectra collected per second as part of the imaging; and
thereafter reconstructing an image from the individual spectrum measurements.

11. The method of claim 1, further comprising:
using the controller to generate a 3D hypercube of data, with first and second dimensions including spatial information, and a third dimension including temporal or spectral information;
thereafter repeating this generation to capture real-time dynamics of the target particle; and
spectrally filtering the resultant images.

12. The method of claim 1, further comprising using polarization between pump light and probe light from the laser light, to act as an internal reference for balancing of the detecting step.

13. The method of claim 1, further comprising exciting and the detecting using different objective lenses, an excitation objective lens generating a light sheet to reject out-of-focus signals, and a detection objective lens collecting light scattered from material inside of the light sheet.

14. A method of spectroscopic bioagent detection, the method comprising:
(a) emitting pump-probe laser pulses on a specimen to optically vibrate the specimen;
(b) spectroscopically detecting a vibrational frequency from the vibrated specimen;
(c) optically identifying the specimen with microscopy;
(d) spatially imaging, in real-time, the specimen, including at least one of:
attachment to, entry into, transport in, assembly to and release from, a live host cell; and
(e) automatically determining a characteristic of the specimen with a programmable controller, the characteristic comprising at least one of: a size, shape, loading, intactness, or activity of the specimen, or surface proteins on the specimen.

15. The method of claim 14, wherein the detecting comprises measuring coherent vibrations of a virion from the specimen in a 0.1-2000 GHz frequency range.

16. The method of claim 14, further comprising using the imaging to assist in identifying a molecule inhibitor drug to block the entry, replication or the release of the specimen from the live host cell.

17. The method of claim 14, further comprising detecting single virus sensitivity while distinguishing between the virus and background molecules.

18. The method of claim 14, further comprising:
measuring a vibrational spectrum at each imaging pixel across a wide field of view which encompasses the live cell;
using single-pixel imaging in which probe light is spatially modulated;
scanning near video frame rates of at least 10,000 spectra collected per second as part of the imaging; and
thereafter reconstructing an image from the individual spectrum measurements with the programmable controller.

19. The method of claim 14, further comprising:
using the programmable controller to generate 3D data, with first and second dimensions including spatial information, and a third dimension including temporal or spectral information;
thereafter repeating the generation to capture real-time dynamics of the specimen; and
spectrally filtering the resultant images;
wherein the specimen comprising a virus or bacterium.

20. The method of claim 14, further comprising using polarization between pump light and probe light from the laser light, to act as an internal reference for balancing of the detecting step, and the specimen comprising a virus or bacterium.

21. The method of claim 14, further comprising exciting and the detecting using different objective lenses, an excitation objective lens generating a light sheet to reject out-of-focus signals, and a detection objective lens collecting light scattered from material inside of the light sheet.

22. A spectroscopic detection apparatus comprising:
(a) a target particle comprising a virus, bacterium or fungus;
(b) at least one laser configured to emit pump-probe laser pulses on the target particle to optically vibrate the target particle;
(c) at least one objective lens configured to focus the laser pulses on the target particle;
(d) a digital detector configured to receive an image of the target particle;
(e) a programmable controller, connected to the detector, configured to determine a vibrational spectrum from the vibrated target particle; and
(f) the programmable controller being configured to determine at least one of: a size, shape, loading, intactness, activity or an identity of the target particle, or surface proteins on the target particle.

23. The apparatus of claim 22, further comprising a polarizer operably polarizing between pump light and probe light from the laser light, and acting as an internal reference for balancing between multiple photodiodes of the detector.

24. The apparatus of claim 22, wherein the at least one objective lens further comprises an excitation objective lens operably generating a light sheet to reject out-of-focus signals, and a detection objective lens operably collecting light scattered from material inside of the light sheet.
